(19) United States
(12) Patent Application Publication
(10) Pub. No.: US 2010/0123047 A1
(43) Pub. Date: May 20, 2010

(54) Blended Wing Body Unmanned Aerial Vehicle

(75) Inventor: Jeffrey L. Williams, Ewa Beach, HI (US)

Correspondence Address: BRYAN CAVE LLP, 211 NORTH BROADWAY, SUITE 3600, ST. LOUIS, MO, 63102-2750, US

(73) Assignee: Williams Aerospace, Inc., Ewa Beach, HI (US)

(21) Appl. No.: 12/271,556

(22) Filed: Nov. 14, 2008

(51) Int. Cl. B64C 3/10; B64C 3/14

(52) U.S. Cl. 244/35 R

(57) ABSTRACT

A Blended Wing Body SUAV and MUAV is disclosed having a novel airfoil profile, wing configuration, rigging and tractor pull propeller placement that provide improved stability and safety characteristics over prior art SUAVs and MUAVs of comparable size and weight. This unique blended wing design includes wing twist on the outboard wing and an inverted “W” shaped planform to provide lateral and longitudinal stability, and smooth, even flight characteristics throughout the range of the expected flight envelope. These flight characteristics are crucial to providing a stable reconnaissance platform with favorable stall speeds, an increased payload and the ability to hand launch without the danger of exposing ones hands or wrist to a propeller.

### TECHNICAL FIELD

This invention pertains to aircraft in the specific area of Unmanned Aerial Vehicles (UAV) or drones, including Small UAVs (SUAV), Micro UAVs (MUAV), and hobbyist aircraft, such as RC (radio controlled) aircraft powered by electric motors.

### BACKGROUND OF THE INVENTION

Current SUAV AND MUAV platforms generally suffer from stability limitations. In addition to the stability issues, SUAV AND MUAV aircraft are usually difficult to fabricate with sufficient skin strength without making the aircraft heavy for its size and limiting its already weight-constrained payload, especially in the case of traditional aircraft designs (wings, fuselage, vertical and horizontal stabilizers).

Traditionally designed SUAVs and MUAVs are also limited in mission duration because there is little room for fuel (gas or batteries). The state of the art for lithium polymer batteries for an aircraft of this size is approximately 1 hour at best. In larger UAVs, recent advances in solar panel, fuel cell, and Zinc-Air battery technologies have shown remarkable progress in extending operational durations up to 22 hours. Recently, some of these larger scale technologies are becoming practical for SUAVs and MUAVs (in terms of weight and volume), and may indeed augment the current lithium polymer battery technology to produce hybrid (electric and gas) propulsion systems that will greatly increase the mission duration of SUAVs and MUAVs.

Blended Wing Body (BWB) UAVs have been designed in recent years to address some of the above short comings of traditional aircraft. Flying wing designs are defined as having no separate body, only a single wing, though there may be structures protruding from the wing. Blended wing/body aircraft have a flattened and airfoil shaped body, which produces most of the lift to keep itself aloft, and distinct and separate wing structures, though the wings are smoothly blended in with the body. These designs capitalize on much lower drag coefficients and a large increase in overall payload for a given class size because of the unique tailless design and the integration of the fuselage into the wing itself. These advanced aircraft designs have other significant advantages that include a more stealthier radar cross section and visible appearance.

Feedback from U.S. soldiers who operate UAVs/SUAVs/MUAVs indicates the need for more compact UAV systems that can be stored and carried in a backpack (rucksack) or can be easily transported in a car, truck or small boat. Additionally, current UAVs require a catapult or bungee launching apparatus to achieve a sufficient flight velocity for takeoff. This can leave troops vulnerable and exposed to attack as they set up the launch mechanism, and the additional equipment adds to their backpack weight and volume. Some flying wing designs were developed and tested with U.S. Special Forces under combat conditions and received negative feedback because of the pusher propeller configuration. Although ideal for keeping the propeller from obstructing the onboard video cameras, the aft propellers were noted for several safety hazards when soldiers tried to hand launch them and were cut by the propeller.

### SUMMARY

In accordance with one embodiment of the present invention, the design of the Blended Wing Body SUAV and MUAV is a novel airfoil profile, wing configuration, rigging and tractor pull propeller placement that provide improved stability and safety characteristics over prior art SUAVs and MUAVs of comparable size and weight. This unique blended wing design includes wing twist on the outboard wing and an inverted “W” shaped planform to provide lateral and longitudinal stability, and smooth, even flight characteristics throughout the range of the expected flight envelope. These flight characteristics are crucial to providing a stable reconnaissance platform with favorable stall speeds, an increased payload and the ability to hand launch without the danger of exposing ones hands or wrist to a propeller.

Additional aspects and advantages will be apparent from the following detailed description of preferred embodiments, which proceeds with reference to the accompanying drawings.

### BRIEF DESCRIPTION OF THE DRAWINGS

FIG. 1 is a top plan view of a generic prior art wing depicting the principal geometric parameters used to define the geometry of a wing.

FIG. 2 is a rear view of a generic prior art wing depicting the principal geometric parameters used to define the geometry of a wing.

FIG. 3 is a side view of a generic prior art wing depicting the principal geometric parameters used to define the geometry of a wing.

FIG. 4 is a rear overhead perspective view of a preferred embodiment of the present invention.

FIG. 5 is a sectional (skeletal) rear overhead perspective view of a preferred embodiment of the present invention.

FIG. 6 is a front overhead perspective view of a preferred embodiment of the present invention.

FIG. 7 is a sectional (skeletal) front overhead perspective view of a preferred embodiment of the present invention.

FIG. 8 is a top plan view or a preferred embodiment of the present invention.

FIG. 9 is a sectional (skeletal) top plan view of a preferred embodiment of the present invention.

FIG. 10 is a front overhead perspective view of a preferred embodiment of the present invention illustrating the dimensions of the wing assembly.

FIG. 11 is a cross-sectional shape of an airfoil in accordance with the present invention, with an imaginary chord line connecting the leading and trailing edges and a series of successive points defining the upper and lower splines.

FIG. 12 is a table of x axis locations on the chord line and the y axis distances from the chord line to points on the upper or lower surfaces defining the airfoil of the preferred embodiment.

FIG. 13 is a top view of the main wing body depicting the principal geometric parameters used to define the curved trailing edge of the main wing body.

### DETAILED DESCRIPTION OF THE PREFERRED EMBODIMENTS

Reference is now made to the figures in which like reference numerals refer to like elements.

In the following description, certain specific details of dimensions, materials, construction methods, etc., are provided for a thorough understanding of the embodiments of the invention. However, those skilled in the art will recognize that the invention can be practiced without one or more of the specific details, or with other dimensions, methods, components, materials, etc.

In some cases, well-known structures, materials, or operations are not shown or described in detail in order to avoid obscuring aspects of the invention. Furthermore, the described features, structures, or characteristics may be combined in any suitable manner in one or more embodiments.

As is known in the art, the design of an aircraft wing can be defined by the geometric parameters and by the airfoil profile.

The principal geometric parameters used to define the geometry of a wing are the following:

wing airfoil profile

half wingspan: b

root chord: Cᵣₒₒₜ

tip chord: Cₜᵢₚ

angle of sweep at 0% of the chord: φ₀

dihedral angle: Γ

twist angle: θ

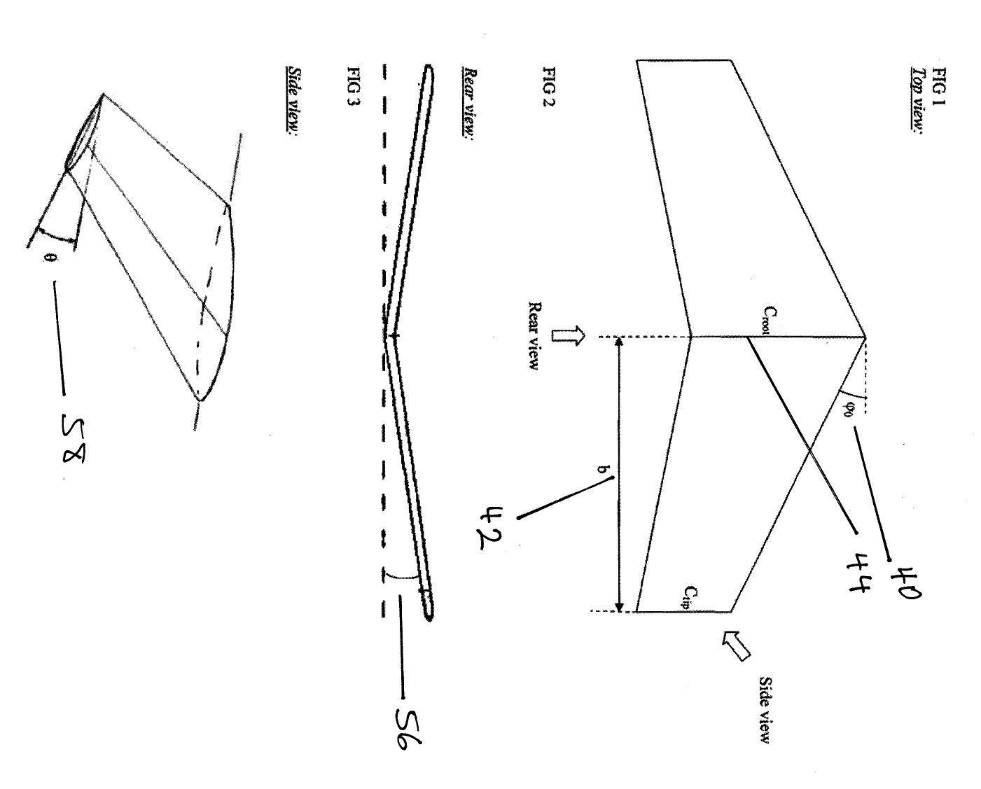

These principal geometric parameters used to define the geometry of a wing are illustrated in FIGS. 1-3, wherein FIG. 1 is a top plan view of a generic prior art wing depicting the principal geometric parameters used to define the geometry of a wing, FIG. 2 is a rear view of a generic prior art wing depicting the principal geometric parameters used to define the geometry of a wing, and FIG. 3 is a side view of a generic prior art wing depicting the principal geometric parameters used to define the geometry of a wing. Illustrated in FIG. 1 are the angle of sweep at 0% of the chord (leading edge): φ₀ 40, half wingspan: b 42, root chord: Cᵣₒₒₜ 44, and tip chord: Cₜᵢₚ 46. Illustrated in FIG. 2 is the dihedral angle: Γ 56, and illustrated in FIG. 3 is the twist angle: θ58.

The present invention provides a design which may utilize new construction methods and materials, such as traditional carbon fiber bi-directional cloth and adding nano-composite filler to the epoxy in a manner similar to adding micro-balloons. This allows the use of single, rather than multiple layers of cloth and thus reduces the airframe weight and yet increases the strength of the skin significantly compared to conventionally constructed aircraft. The result is a remarkably light aircraft that can withstand hard landings and crashes.

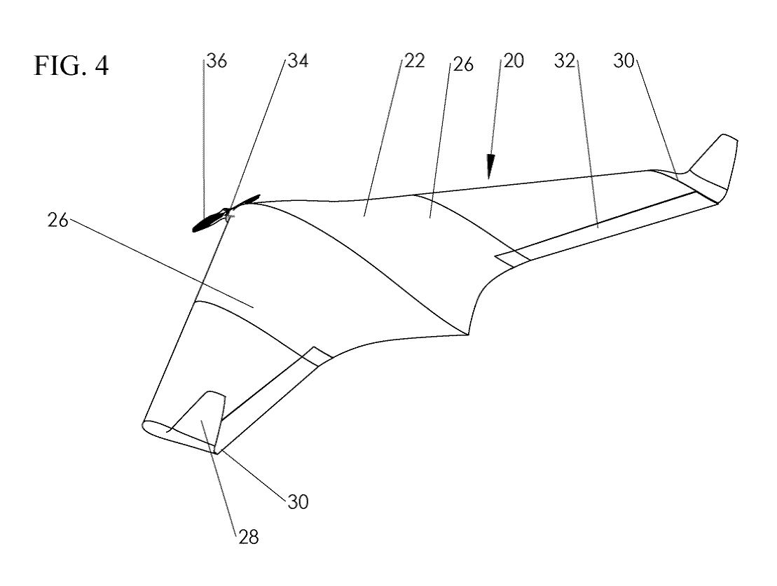

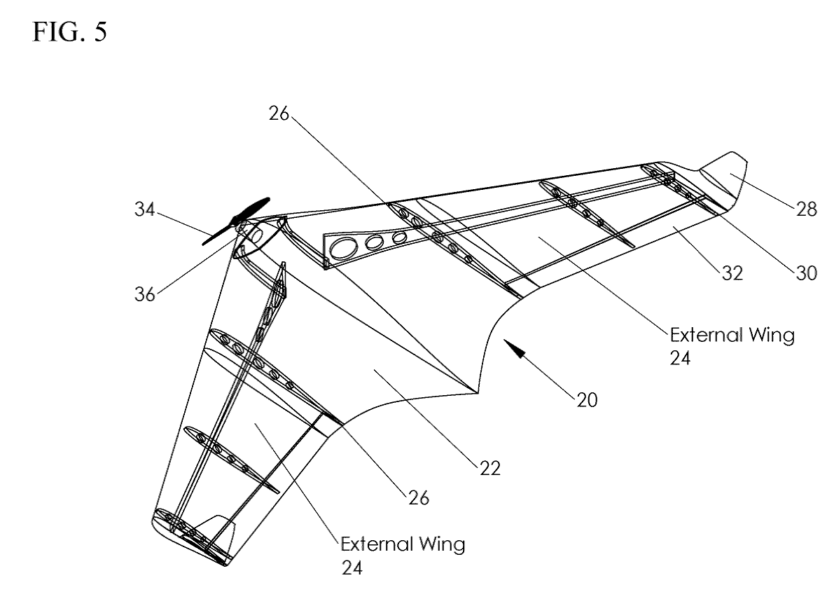

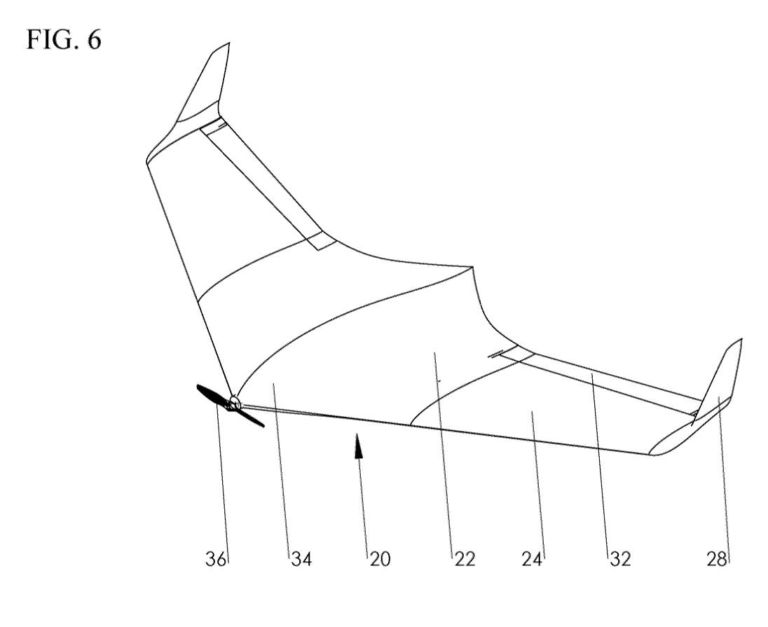

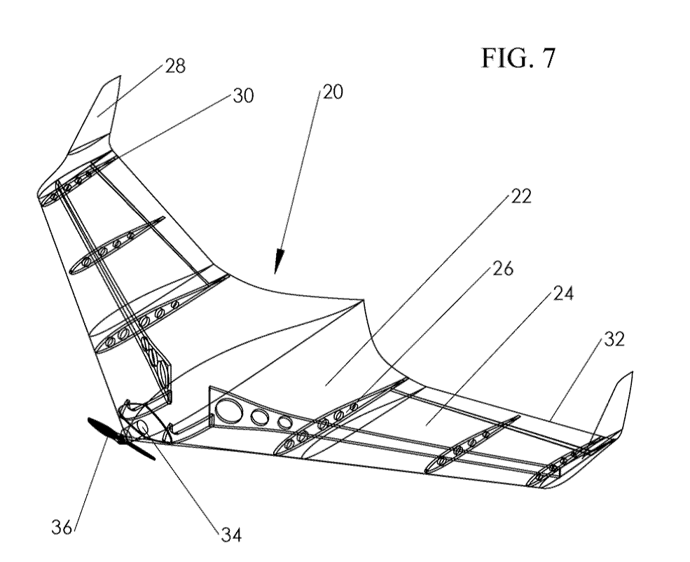

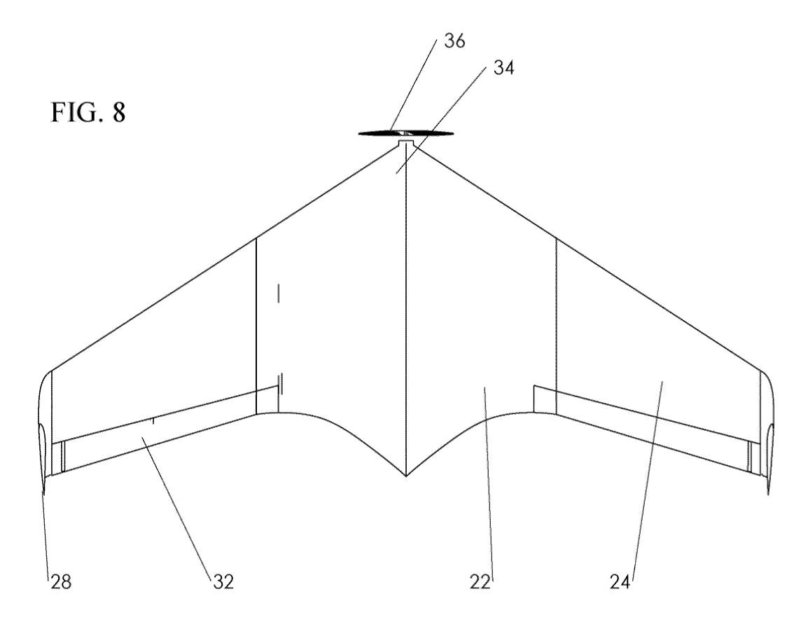

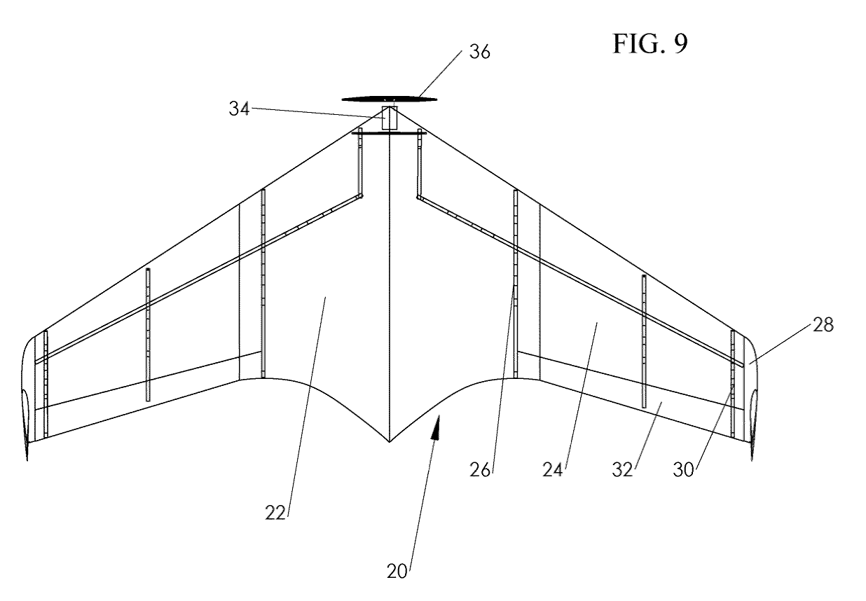

FIG. 4 is a rear overhead perspective view of a preferred embodiment of the present invention and FIG. 5 is a sectional (skeletal) rear overhead perspective view of a preferred embodiment. FIG. 6 is a front overhead perspective view of a preferred embodiment of the present invention and FIG. 7 is a sectional (skeletal) front overhead perspective view. FIG. 8 is a top plan view of a preferred embodiment of the present invention and FIG. 9 is a sectional (skeletal) top plan view. As shown in FIGS. 4-9, the wing 20 of the preferred embodiment is composed of a main body wing 22 and two external wings 24 joined at the outboard edges 26 of the main wing 22. Preferably, winglets 28, oriented in an approximately vertical direction, may be formed at the outboard edges 30 of the external wings 24.

The airfoil configuration used on the main wing 22, external wings 24 and wing tips provides relatively high camber for good lift characteristics, and a reflex curve on the underside of the airfoil that allows stabilization of the aircraft without the need for a tail or empennage. The wings are controlled by elevons 32 located on the trailing edge of the external wing sections. These elevons 32 control both pitch and roll of the aircraft through “mixed” inputs of the type used to control conventional elevator and aileron control surfaces.

The preferred embodiment SUAV or MUAV may be driven by a propeller 36 powered by an electric motor preferably located in a nacelle on the nose 34 of the aircraft.

### Main Wing

The angular geometric parameters of the main wing of a preferred embodiment of present invention are provided below, wherein the units used are degrees for angles.

angle of sweep at 0% of the chord (leading edge): φ₀=33°

dihedral angle: Γ=0°

twist angle: θ=0°

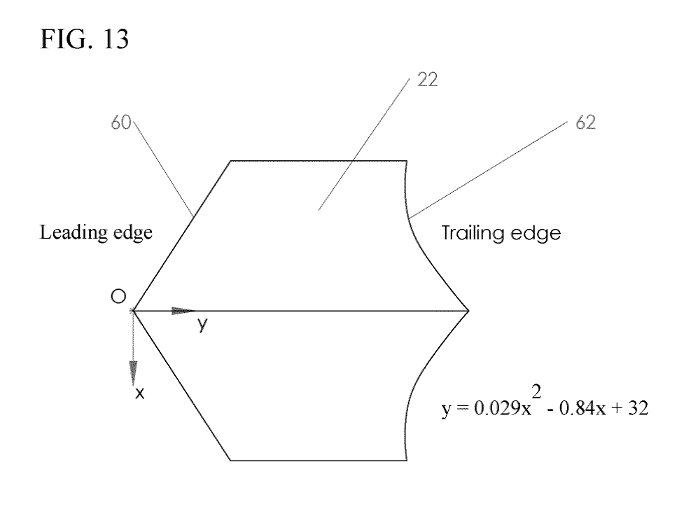

The trailing edge of the main wing section is a curved spline uniquely defined by a second degree order polynomial whose equation is y=0.029x²−0.84x+32 where the origin and direction of the coordinate system is shown in FIG. 13.

The dimensional geometric parameters of the main wing segments of a preferred embodiment MUAV of the present invention are provided below, wherein the units used are inches for lengths.

half wingspan: b=8.5″

root chord: Cᵣₒₒₜ=9″

tip chord: Cₜᵢₚ=4.05″

The dimensional geometric parameters of the main wing segments of a preferred embodiment SUAV of the present invention are provided below, wherein the units used are inches for lengths.

half wingspan: b=14.3″

root chord: Cᵣₒₒₜ=32″

tip chord: Cₜᵢₚ=16.8″

### External Wings

The angular geometric parameters of the main wing of a preferred embodiment of the MUAV or an SUAV of the present invention are provided below, wherein the units used are degrees for angles.

angle of sweep at 0% of the chord (leading edge): φ₀=33°

dihedral angle: Γ=0°

twist angle: θ=4°

The dimensional geometric parameters of the external wing segments of a preferred embodiment of MUAV of the present invention are provided below, wherein the units used are inches for lengths.

half wingspan: b=6″

root chord: Cᵣₒₒₜ=4.05″

tip chord: Cₜᵢₚ=2.85″

The dimensional geometric parameters of the external wing segments of a preferred embodiment of SUAV of the present invention are provided below, wherein the units used are inches for lengths.

half wingspan: b=19.45″

root chord: Cᵣₒₒₜ=16.8″

tip chord: Cₜᵢₚ=10″

In a preferred embodiment of MUAV of the present invention the elevons 32 have a chord of approximately 1″ and a wingspan of 6″. In a preferred embodiment of SUAV of the present invention the elevons 32 have chords of 2.6″ and 3″, and a wingspan of 22.3.″

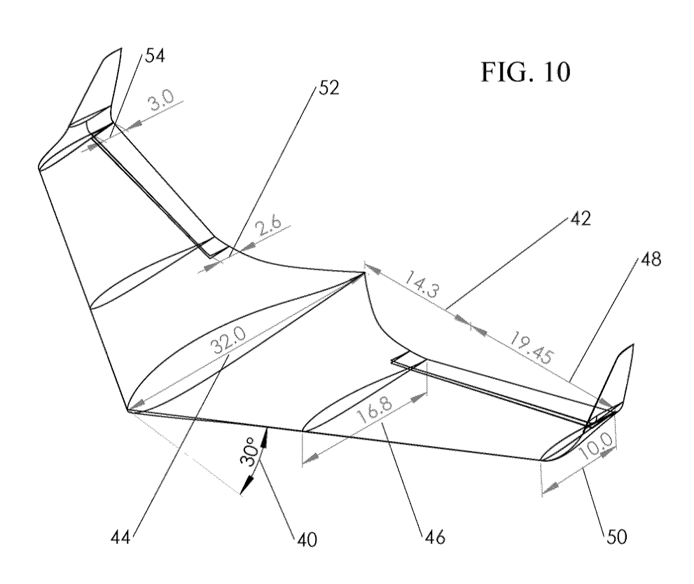

These dimensions of the wing assembly of the preferred embodiment are illustrated in FIG. 10, wherein the following geometric and dimensional parameters are identified with the respective numbered elements:

| Main Wing Parameters | Element No. | SUAV | MUAV |
|---|---|---|---|
| angle of sweep at 0% of the | 40 | 33° | 33° |
| chord (leading edge): φ₀ | | | |
| half wingspan: b | 42 | 14.3″ | 8.5″ |
| root chord: Cᵣₒₒₜ | 44 | 32″ | 9″ |
| tip chord: Cₜᵢₚ | 46 | 16.8″ | 4.05″ |

| External Wing Parameters | Element No. | SUAV | MUAV |
|---|---|---|---|
| angle of sweep at 0% of the | 40 | 33° | 33° |
| chord (leading edge): φ₀ | | | |
| half wingspan: b | 48 | 19.45″ | 6″ |
| root chord: Cᵣₒₒₜ | 46 | 16.8″ | 4.05″ |
| tip chord: Cₜᵢₚ | 50 | 10″ | 2.85″ |

| Elevons (32) | Element No. | SUAV | MUAV |
|---|---|---|---|
| Inner chord | 52 | 2.6″ | 1″ |
| Outer chord | 54 | 3″ | 1″ |

As is known and appreciated by those skilled in the art, variations from the indicated dimensions may be made without departing from the underlying principles of the invention. For example, the wingspan dimension of the wing assembly of the preferred embodiment may be extended to the range of 4 to 5 feet in accordance with the present invention.

### Wing Airfoil

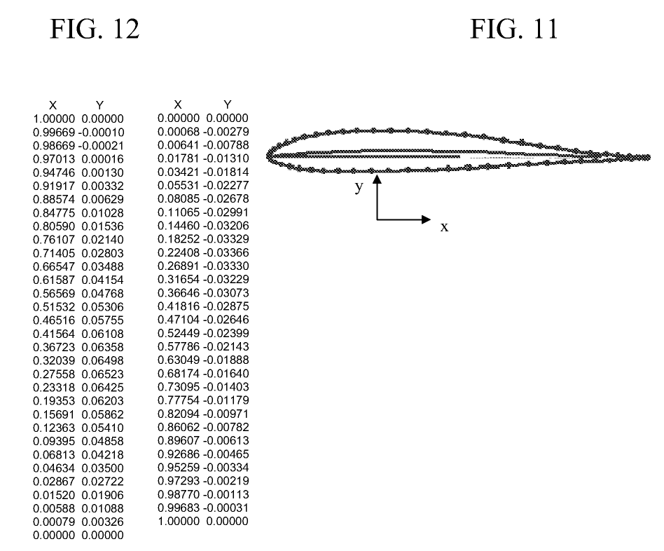

The preferred embodiment of the invention includes an airfoil used in the wing of a low-speed unmanned aircraft. Preferably, both main and external wings exhibit approximately the same airfoil configuration. The airfoil of a wing is the shape as seen in cross-section. The geometry of the airfoil of the preferred embodiment may be defined by the coordinates of successive points of the upper and lower splines as shown in FIG. 11.

The airfoil of the preferred embodiment has upper and lower surfaces defined at x axis locations on the chord line and the y axis distances from the chord line to points on the upper or lower surfaces, as shown in FIG. 11, with the x axis locations and y axis distances of the points corresponding substantially to the table in FIG. 12.

Another parameter for every airfoil or wing cross-section is its operating Reynolds number. The Reynolds number of an airfoil at a particular location along the span of the wing is dimensionless and is defined by the following equation: R=cV/.nu., where R is the Reynolds number, c is the chord of the airfoil, V is the free-stream flow velocity, and .nu. is the kinematic viscosity of the air. Physically, the Reynolds number represents the ratio of the inertial forces to the viscous forces of air flow over a wing.

Airfoil performance characteristics are a function of the airfoil's Reynolds number. As the velocity of air over a wing and/or the chord length of a wing decrease, the wing's Reynolds number decreases. A small Reynolds number indicates that viscous forces predominate, while a large Reynolds number indicates that inertial forces predominate.

The airfoil of the present invention can be applied over a range of chords; preferably, each airfoil has a thickness of 10.12%, a Reynolds number in a range of approximately 20,000 to 500,000, most preferably approximately 150,000, and a maximum lift coefficient in a range of about 1.1 and a low moment coefficient of cm_{0.25}=+0.0140.

### Stability

Stability is a very important aspect of aircraft performance, particularly for small aircraft sizes such as the SUAV and MUAV. The Reynolds Numbers involved are very low and the aerodynamic associated becomes very complex. Stability in an aircraft is analyzed in terms of the three dimensional axes of the pitch axis, the roll axis and the yaw axis. The pitch stability is the main concern in this SUAV and MUAV design.

### Longitudinal Stability (Stability in Pitch):

The main design parameters influencing longitudinal stability are the sweep angle, the airfoil shape, the Center of Gravity (CG) position, and the twist angle. In addition to the airfoil shape disclosed above, the preferred embodiment achieves longitudinal stability with the following parameters:

Main Wing: —sweep angle=33°
twist angle: θ=0°
   External Wings—sweep angle=33°
twist angle: θ=4°
   CG position=5.14″ from the root leading edge
   The curved trailing edge of the main wing body also provides a unique improvement of the stability by increasing the reflexed area in the aft part of the wing. The curved portion of the trailing edge is defined by the polynomial y=0.029x²−0.84x+32 and is illustrated in FIG. 13. FIG. 13 depicts the leading edge 60 of the main wing body 22, and the curved trailing edge 62 of the main wing body 22.

It will be obvious to those having skill in the art that many changes may be made to the details of the above-described embodiments without departing from the underlying principles of the invention. The scope of the present invention should, therefore, be determined only by the following claims.

I claim:

1. A wing assembly comprising a central main wing having outer edges and external wings joined to the main wing at the outer edges and wherein the main wing has geometric parameters corresponding substantially to the following table:
angle of sweep at 0% of the chord (leading edge): φ₀=33°
dihedral angle: Γ=0°
twist angle: θ=0°
trailing edged defined by the equation: y=0.029x²−0.84x+32

2. The wing assembly of claim 1 wherein the main wing has geometric parameters corresponding substantially to the following table:
half wingspan: b=14.3″
root chord: Cᵣₒₒₜ=32″
tip chord: Cₜᵢₚ=16.8″

3. The wing assembly of claim 1 wherein the external wings have geometric parameters corresponding substantially to the following table:
angle of sweep at 0% of the chord (leading edge): φ₀=33°
dihedral angle: Γ=0°
twist angle: θ=4°

4. The wing assembly of claim 3 wherein the external wings have geometric parameters corresponding substantially to the following table:
half wingspan: b=19.45″
root chord: Cᵣₒₒₜ=16.8″
tip chord: Cₜᵢₚ=10″

5. The wing assembly of claim 2 wherein the main wing has a pair of elevons on the outboard trailing edge.

6. The wing assembly of claim 3 wherein the elevons have a spanwise varying chord dimension in the range of approximately from 2.6″ to 3″ and a wingspan dimension of approximately of 19.45″.

7. The wing assembly of claim 1, wherein the airfoil has a Reynolds number in the range from 20,000 to 500,000.

8. The wing assembly of claim 3 wherein the external wings have a half wingspan dimension in the range of approximately 6 to 48 inches.

9. The wing assembly of claim 8 further comprising a nacelle adapted for receiving a motor, the nacelle formed in the forward portion of the main wing along the flight axis of the main wing.

10. The wing assembly of claim 1, wherein the airfoil has a Reynolds number in the range from 2,000,000 to 3,000,000.

11. The wing assembly of claim 2 wherein the main wing comprises an airfoil having an upper surface, a lower surface, and a chord line, said airfoil having upper and lower surfaces defined at x axis locations on the chord line and the y axis distances from the chord line to points on the upper or lower surfaces, wherein the x axis locations and y axis distances correspond substantially to the following table:
